(19) United States
(12) Patent Application Publication
(10) Pub. No.: US 2026/0017325 A1
(43) Pub. Date: Jan. 15, 2026

(54) AUTOMATED REPORT GENERATION USING RETRIEVAL AUGMENTED SYSTEM AND LARGE LANGUAGE MODEL

(71) Applicant: Hamilton Sundstrand Corporation, Charlotte, NC (US)

(72) Inventors: Balasundar Kuppusamy, Bangalore (IN); Feng Feng, South Windsor, CT (US); Pravin Kumar Devadoss Mario, Hyderabad (IN)

(21) Appl. No.: 19/261,794

(22) Filed: Jul. 7, 2025

(30) Foreign Application Priority Data
Jul. 12, 2024 (IN) 202441053264

(51) Int. Cl. G06F 16/9038; G06F 16/22; G06F 16/93

(52) U.S. Cl. CPC G06F 16/9038; G06F 16/2237; G06F 16/93

(57) ABSTRACT

A method includes creating a document retrieval and large language model architecture including at least one vector database including vectorized data corresponding to one or more documents from one or more document storage locations and a large language model. The method also includes receiving a query to generate a report associated with a current project using the large language model. The method also includes returning, in response to the query, a relevant context generated using the at least one vector database. The method also includes generating and outputting, using the large language model and based on the relevant context, one or more portions of the report.

### CROSS-REFERENCE TO RELATED APPLICATION AND PRIORITY CLAIM

This application claims priority under 35 U.S.C. § 119 to Indian Provisional Patent Application No. 202441053264 filed on Jul. 12, 2024, which is hereby incorporated by reference in its entirety.

### TECHNICAL FIELD

This disclosure relates generally to machine learning systems. More specifically, this disclosure relates to automated report generation using a retrieval augmented system and a large language model.

### BACKGROUND

Documentation of the work executed is one of the important tasks of any project. For structural analysis tasks, for example, the work carried out can be presented in the form of a stress report. Stress report writing consumes significant time and effort and contributes to almost 15% to 20% of project time.

### SUMMARY

This disclosure provides for automated report generation using a retrieval augmented system and a large language model.

In some examples, a method includes creating a document retrieval and large language model architecture including at least one vector database including vectorized data corresponding to one or more documents from one or more document storage locations and a large language model. The method also includes receiving a query to generate a report associated with a current project using the large language model. The method also includes returning, in response to the query, a relevant context generated using the at least one vector database. The method also includes generating and outputting, using the large language model and based on the relevant context, one or more portions of the report.

In one or more of the above examples, generating and outputting the one or more portions of the report includes creating portions of the report based on the one or more documents from the one or more document storage locations according to a report schema.

In one or more of the above examples, the report schema defines various formatting and structural parameters for the report.

In one or more of the above examples, the document retrieval and large language model architecture includes a retrieval augmented generation (RAG) system including the at least one vector database and a similarity search operation for generating the relevant context for use by the large language model.

In one or more of the above examples, the similarity search operation is configured to search for and cluster vectors in the at least one vector database.

In one or more of the above examples, creating the document retrieval and large language model architecture includes splitting contents of the one or more documents stored in the one or more document storage locations into chunks, creating, using an embedding machine learning model, a plurality of vector embeddings from the chunks, and storing the plurality of vector embeddings in the at least one vector database.

In one or more of the above examples, the at least one vector database includes a first vector database and a second vector database, wherein the first vector database includes vectorized data corresponding to documents pertaining to prior data associated with projects other than the current project, and wherein the second vector database includes vectorized data corresponding to documents pertaining to current data associated with the current project.

In one or more of the above examples, the method further includes determining whether to modify the report with additional information.

In one or more of the above examples, determining whether to modify the report with additional information includes reviewing, using a second large language model, one or more outputs from the large language model and determining, based on the review using the second large language model, whether to generate new outputs using the large language model.

In one or more of the above examples, the review using the second large language model provides feedback on an accuracy of the one or more outputs from the large language model.

In one or more of the above examples, based on determining not to modify the report with additional information, generating and outputting the one or more portions of the report includes creating portions of the report based on the documents pertaining to the prior data.

In one or more of the above examples, based on determining to modify the report with additional information, generating and outputting the one or more portions of the report includes creating portions of the report based on the documents pertaining to the prior data and creating portions of the report based on the documents pertaining to the current data associated with the current project.

In one or more of the above examples, creating portions of the report based on the documents pertaining to the prior data and creating portions of the report based on the documents pertaining to the current data associated with the current project includes using a third large language model to generate queries based on the current data associated with the current project to retrieve another relevant context associated with the current data, creating a new input by combining one or more responses from the large language model with information pertaining to the current data and sending the new input to the large language model to generate another response, and generating one or more outputs based on the new input and the retrieved other context.

In other examples, an electronic device includes at least one processing device and memory. The memory includes instructions that, when executed by the at least one processing device, are configured to cause the electronic device to create a document retrieval and large language model architecture including at least one vector database including vectorized data corresponding to one or more documents from one or more document storage locations and a large language model. The memory also includes instructions that, when executed by the at least one processing device, are configured to cause the electronic device to receive a query to generate a report associated with a current project using the large language model. The memory also includes instructions that, when executed by the at least one processing device, are configured to cause the electronic device to return, in response to the query, a relevant context generated using the at least one vector database. The memory also includes instructions that, when executed by the at least one processing device, are configured to cause the electronic device to generate and output, using the large language model and based on the relevant context, one or more portions of the report.

In one or more of the above examples, the instructions that, when executed by the at least one processing device, are configured to cause the electronic device to generate and output the one or more portions of the report are further configured to cause the electronic device to create portions of the report based on the one or more documents from the one or more document storage locations according to a report schema.

In one or more of the above examples, the report schema defines various formatting and structural parameters for the report.

In one or more of the above examples, the document retrieval and large language model architecture includes a retrieval augmented generation (RAG) system including the at least one vector database and a similarity search operation for generating the relevant context for use by the large language model.

In one or more of the above examples, the similarity search operation is configured to search for and cluster vectors in the at least one vector database.

In one or more of the above examples, the instructions that, when executed by the at least one processing device, are configured to cause the electronic device to create the document retrieval and large language model architecture are further configured to cause the electronic device to split contents of the one or more documents stored in the one or more document storage locations into chunks, create, using an embedding machine learning model, a plurality of vector embeddings from the chunks, and store the plurality of vector embeddings in the at least one vector database.

In one or more of the above examples, the at least one vector database includes a first vector database and a second vector database, wherein the first vector database includes vectorized data corresponding to documents pertaining to prior data associated with projects other than the current project, and wherein the second vector database includes vectorized data corresponding to documents pertaining to current data associated with the current project.

In one or more of the above examples, the instructions, when executed by the at least one processing device, are further configured to cause the electronic device to determine whether to modify the report with additional information.

In one or more of the above examples, the instructions that, when executed by the at least one processing device, are configured to cause the electronic device to determine whether to modify the report with additional information are further configured to cause the electronic device to review, using a second large language model, one or more outputs from the large language model and determine, based on the review using the second large language model, whether to generate new outputs using the large language model.

In one or more of the above examples, the review using the second large language model provides feedback on an accuracy of the one or more outputs from the large language model.

In one or more of the above examples, based on a determination not to modify the report with additional information, the instructions that, when executed by the at least one processing device, are configured to cause the electronic device to generate and output the one or more portions of the report are further configured to cause the electronic device to create portions of the report based on the documents pertaining to the prior data.

In one or more of the above examples, based on a determination to modify the report with additional information, the instructions that, when executed by the at least one processing device, are configured to cause the electronic device to generate and output the one or more portions of the report are further configured to cause the electronic device to create portions of the report based on the documents pertaining to the prior data and create portions of the report based on the documents pertaining to the current data associated with the current project.

In one or more of the above examples, the instructions that, when executed by the at least one processing device, are configured to cause the electronic device to create portions of the report based on the documents pertaining to the prior data and create portions of the report based on the documents pertaining to the current data associated with the current project further are further configured to cause the electronic device to use a third large language model to generate queries based on the current data associated with the current project to retrieve another relevant context associated with the current data, create a new input by combining one or more responses from the large language model with information pertaining to the current data and sending the new input to the large language model to generate another response, and generate one or more outputs based on the new input and the retrieved other context.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example process for augmented report generation in accordance with this disclosure;

FIG. 2 illustrates an example class definition for automated report generation in accordance with this disclosure;

FIG. 3 illustrates an example method for augmented report generation in accordance with this disclosure; and

FIG. 4 illustrates an example electronic device in accordance with this disclosure.

### DETAILED DESCRIPTION

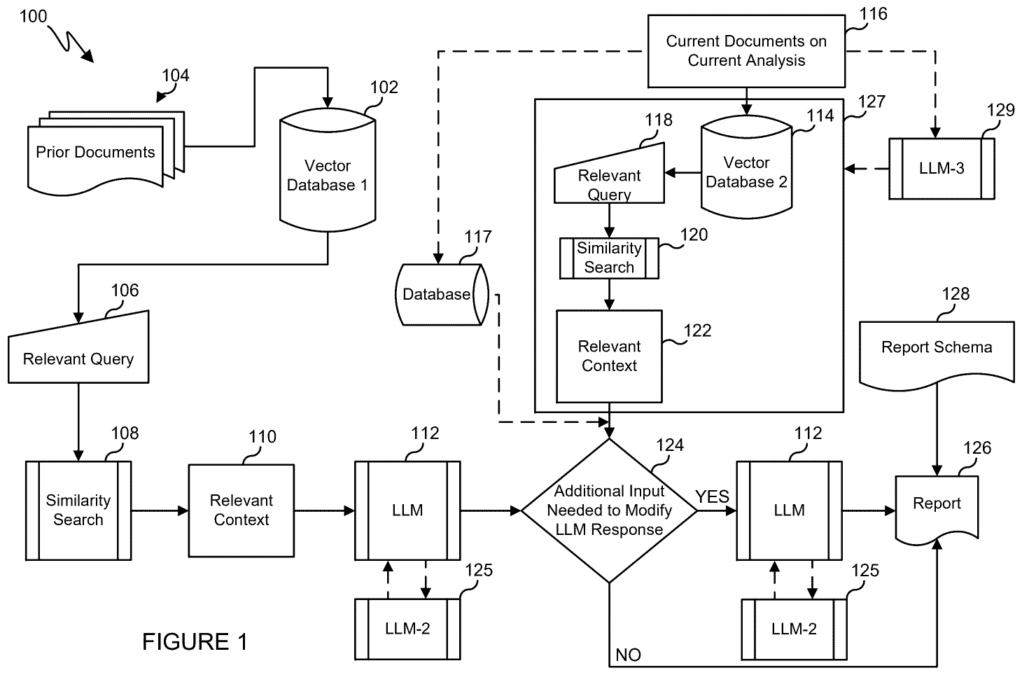

FIGS. 1 through 4, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

Documentation of the work executed is one of the important tasks of any project. For structural analysis tasks, for example, the work carried out can be presented in the form of a stress report. Stress report writing consumes significant time and effort and contributes to almost 15% to 20% of project time.

Attempts to reduce the time and effort involved in creating reports have failed to effectively automate such a process. Particularly, outputs were not modified based on established or known data to achieve accurate report results.

This disclosure provides for automated report generation using a retrieval augmented system and a large language model where a large language model (LLM) is used to generate a report, such as a stress report, from data corresponding to existing report documents, where the existing report documents have been converted into vector data for use by the LLM and/or other components of the system. This disclosure also provides for determining if an initial output by the LLM should be modified using other information pertaining to data on relevant analyses to a current project, and, if so, the LLM output is modified by providing the other information to the LLM to manipulate the final output report. This disclosure also provides for using report schema to further control the format and structure of the final output report.

FIG. 1 illustrates an example process 100 for augmented report generation in accordance with this disclosure. As shown in FIG. 1, the process 100 includes creating a first vector database 102 using one or more collected prior or pre-existing documents 104. The prior documents 104 can be related to the current project on which the report is being generated, or the prior documents 104 can include any other document related to the product and/or process that is the subject of the current project. For instance, for stress report automation, the documents can be past stress reports of products, product catalogues, product bill of materials, material database, applicable standards, customer requirement documents, manufacturing documents, assembly procedures and/or any other document which will assist in creation of stress reports. These documents can be of any format, and they will be converted to a common format, such as the PORTABLE DOCUMENT FORMAT (PDF), for further processing.

For example, if the current project is to create a stress report on a particular windshield wiper system, the prior documents could include documents pertaining to the particular windshield wiper system, such as test results on the particular windshield wiper system, or could be documents related to the product type, such as prior reports and/or test results on other windshield wiper systems or other vehicle systems generally. The prior documents 104 provide information that is used by the process 100 to learn the typical structures, formatting, and content style of project reports created by an entity using the process 100 so that the ultimate report generated by the process 100 adheres to expected parameters. The prior documents 104 are vectorized for storage in the first vector database 102 by creating using, a machine learning process, vector embeddings of the prior documents 104 that include numerical vector values representing the contents of the documents 104. In various embodiments, the prior documents 104 are split into smaller chunks, such as via a recursive text splitting operation. This can include creating a question-answer chain such that one or more relevant queries 106 can be used for obtaining relevant information from the first vector database 102. The first vector database 102 is built by creating the vector embeddings from the chunks using, for example, an embedding large language model (LLM), such that the first vector database 102 is built to be compatible with a similarity search operation 108 that is used to generates a relevant context 110 used by an LLM 112 used for response generation for the report. In various embodiments, the similarity search operation 108 is configured to search for and cluster dense vectors. The similarity search operation 108 can find information in the first vector database 102 most similar to the query provided by the user.

A second vector database 114 can be created in a similar manner, but using current documents 116 (that can also be stored in database 117, which can be of various database types such as a vector database, a SQL database, a MONGO database, etc.) that include information on the current project, such as all relevant documents on a product, process, etc. under review, e.g., the particular windshield wiper system used in the example above. For example, the current documents 116 can be the results from current stress analyses, such as documents including images, tabular data, and text information regarding the current analyses on a product, process, etc. The prior documents 104 and the current documents 116 can be of various formats, such as JSON, text, MICROSOFT WORD, PDF, or other formats. One or more relevant queries 118 can be used for obtaining relevant information from the second vector database 114. The second vector database 114 also is built to be compatible with a similarity search operation 120 that generates a relevant context 122 for use by the LLM 112.

The ability of the LLM 112 to reference the first and second vector databases 102, 114 provides for retrieval augmented generation (RAG) of outputs using the LLM 112. That is, use of this RAG architecture optimizes the output of the LLM 112 so that the LLM 112 can reference an authoritative knowledge base, i.e., the first and second vector databases 102, 114, outside of its training data sources before generating a response. RAG extends the capabilities of the LLM 112 to specific domains and/or an organization's internal knowledge base, without the need to retrain the LLM 112, and while still improving the LLM 112 to have tailored knowledge that is relevant, accurate, and useful in the specific context in which the LLM 112 resides.

Once the RAG architectures for the prior documents 104 and current documents 116 are established, a user can request the LLM to generate a report and, in response, the first vector database 102 is queried, based on the user input to the LLM, via a relevant query 106 to obtain relevant information in the form of a relevant context 110. The relevant context is used by the LLM 112 to retrieve documents relevant to the current project via the similarity search operation 108. In some embodiments, documents can be retrieved using the similarity search operation 108 based on a set retrieval function in which certain query types retrieve certain linked documents. In some embodiments, similarity search operation 108 can be used to determine documents based on a similarity score, such as documents that are within a distance score threshold to the query. In some embodiments, the similarity search operation 108 can be used to find documents with a similar embedding vector as in the query.

The retrieved documents obtained using the first vector database 102 and the LLM 112 can be used to generate responses for sections of the report that do not need current data, that is data specific to the current documents 116, for example a generic introduction section of a product or a process report.

At step 124 of the process 100, it is determined additional input is needed to modify the response/output of the LLM 112. This can include using a second LLM 125, which is a reviewer LLM that reviews the output from writer LLM 112, and provides feedback on the quality of the content, which can include evaluating both language quality and technical quality of the content. If not, a report 126, e.g., a stress report, is generated using just the outputs of the LLM 112 obtained using the first vector database 102.

However, if it is determined at step 124 that additional input is needed to modify the response/output of the LLM 112, the LLM 112 can generate new text based on the feedback from the second LLM 125. For example, if there are sections of the report to be generated that require information included in the current documents 116, then RAG architecture 127 associated with the second vector database 114 is used to obtain the relevant context 122 to populate sections of the report 126 to include data/analyses on the current project.

For instance, to obtain the relevant context, a third LLM 129 can be used to generate relevant queries based on the current data, e.g., the current documents 116. These queries are used to retrieve the context 122, and the style of the context 122 is used for writing data based on the current documents 116 into the report. In various embodiments, the retrieved information/contexts from both the first and second vector database 102, 114 are used along with the LLM 112 to generate responses for sections of the report 126 that need current data as well as past data, for example a stress analysis results section where a comparison can be made between current cases with past cases. In some embodiments, the process 100 can loop at steps 124-128, such that the second LLM 125 can be used multiple times to evaluate the outputs from the LLM 112 to determine if additional data such as additional data on the current documents 116 is needed for the report, or if additional user input is needed.

In some embodiments, the additional input obtained at step 124 can include a user input. For example, a user, based on the particular need, can add some text to the response generated by the LLM 112 in the previous step and the user can instruct the LLM 112 to modify the final response as per the requirements. In some embodiments, the user input can include a project number that is associated with a current project. In various embodiments, providing the project number causes the second vector database 114 to be created by retrieving documents associated with the project number and vectorizing those documents associated with the project number for storage in the second vector database 114, as described above. In some embodiments, the second vector database 114 may have already been created previously, and providing the project number informs the LLM 112 which vector database to use to answer the query.

In various embodiments of this disclosure, the generated responses from the LLM 112 are used to complete the report 126 according to a report schema 128. The report schema 128 can be a template created based on various report formatting and structure requirements, and can be created manually or automatically. In some embodiments, the report schema 128 can be a CSV file or other similar file type. To populate the report 126, a prompt template can be defined in-line with the report schema 128 so that outputs from the LLM 112 based on user queries to the RAG systems to generate the relevant context are used to populate specific portions of the report 126. That is, the RAG generated context is fed to the LLM 112 to generate a response. In some embodiments, the final report 126 can also include tables and figures which can be inserted automatically using programming (PYTHON) scripts and/or using multimodal LLMs, such as the LLM 112.

The process 100 using the architecture shown in FIG. 1 can reduce the time it takes to generate reports by as much as 50-60%. Additionally, the LLM 112 can provide additional insights into conclusions by considering all the available data which often is impractical for users to find and include. For example, for a particular component, design under a specific load case might have yielded a negative margin in the past and the designer might have done some design changes or got an exception from the chief engineer for that load case. Using the process 100 and the LLM 112, improved analysis plans can be created and designs can be validated efficiently for during component design processes.

Although FIG. 1 illustrates one example of a process 100 for augmented report generation, various changes may be made to FIG. 1. For example, various components and functions in FIG. 1 may be combined, further subdivided, replicated, or rearranged according to particular needs. Also, one or more additional components and functions may be included if needed or desired. Also, while shown as a series of steps, various steps in FIG. 1 could overlap, occur in parallel, occur in a different order, or occur any number of times (including zero times).

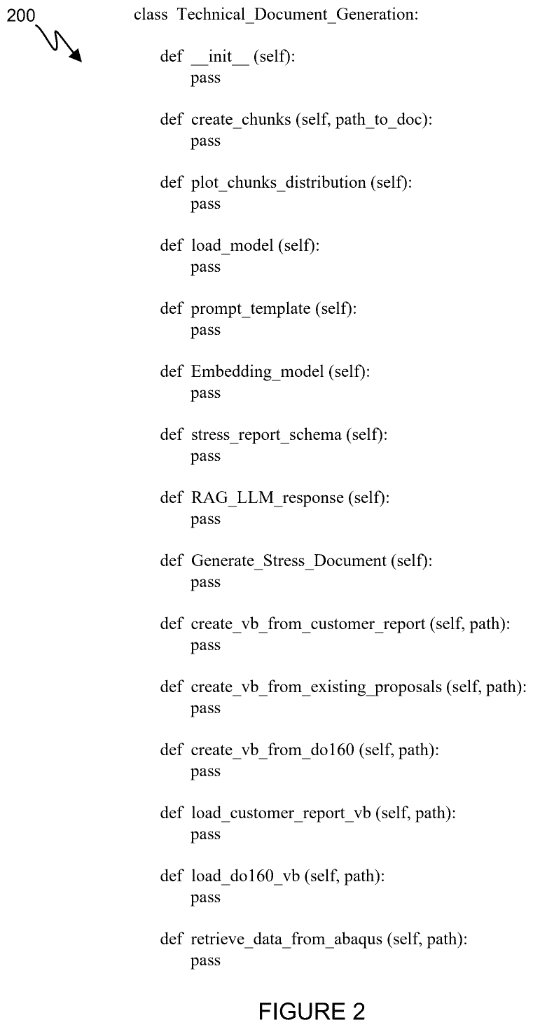

FIG. 2 illustrates an example class definition 200 for automated report generation in accordance with this disclosure. As shown in FIG. 2, the class definition 200 includes the methods representing the operations for performing automated report generation flowing programmatically, such as the operations performed as part of the process 100.

For instance, as shown in FIG. 2, a class is defined titled “Technical_Document_Generation.” The class definition 200 further includes definitions of various functions used for performing automated report generation. For example, the class definition 200 defines, among other functions, a function to create chunks (“def create_chunks”) that includes a document path for splitting a document found at the document path into smaller chunks for use by the RAG and LLM system. The class definition 200 can also define a function to plot the distribution of chunk lengths (“def plot_chunks_distribution”), a function to load the model (“def load_model”), a function provides a prompt template (“def prompt_template”), a function to call an embedding model to create the vector embeddings for the vector databases (“def Embedding_model”). As shown in FIG. 2, the class definition 200 can further define a function to obtain report schema (“def stress_report_schema”), a function for obtaining a response from the RAG and LLM system (“def RAG_LLM_response”), a function to generate a report, such as a stress report (“def Generate_Stress_Document”), a function to use data from customer reports (“def create_vb_from_customer_report”), a function to use data from existing proposals (“def create_vb_from_existing_proposals”)

Although FIG. 2 illustrates one example of a class definition 200 for automated report generation, various changes may be made to FIG. 2. For example, while FIG. 2 illustrates defining the class using PYTHON, any other programming language can be used without departing from the scope of this disclosure.

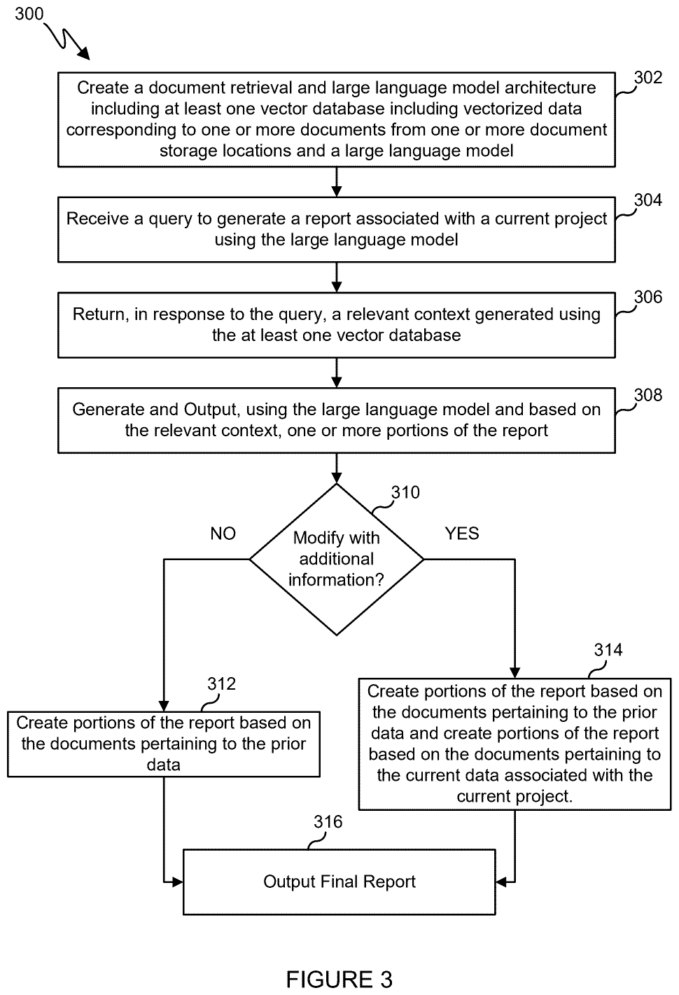

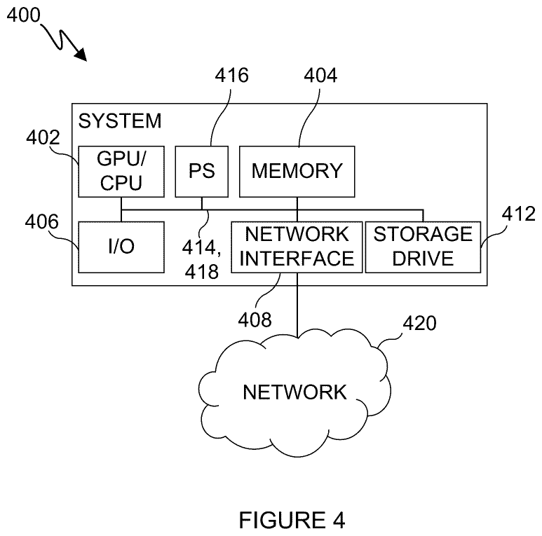

FIG. 3 illustrates an example method 300 for augmented report generation in accordance with this disclosure. For case of explanation, the method 300 shown in FIG. 3 may be described as being performed using the electronic device 400 of FIG. 4, and/or the processor of the electronic device 400, and the architecture shown in the process 100 of FIG. 1. However, the method 300 could be performed using any other suitable device(s), and in any other suitable system(s).

As shown in FIG. 3, at step 302, a document retrieval and large language model architecture is created, such as that shown in FIG. 1. In various embodiments, the document retrieval and large language model architecture includes at least one vector database (such as vector databases 102, 114) including vectorized data corresponding to one or more documents from one or more document storage locations and a large language model (such as the LLM 112).

At step 304, a query to generate a report associated with a current project using the large language model is received. At step 306, in response to the query, a relevant context generated using the at least one vector database is returned. At step 308, one or more portions of the requested report are generated and output using the large language model and based on the relevant context. In various embodiments, generating and outputting the one or more portions of the report includes creating portions of the report based on the one or more documents from the one or more document storage locations according to a report schema, such as the report schema 128 of FIG. 1. In various embodiments, the report schema defines various formatting and structural parameters for the report.

In various embodiments, the document retrieval and large language model architecture includes a retrieval augmented generation (RAG) system including the at least one vector database and a similarity search operation (such as the similarity search operation 108) for generating the relevant context for use by the large language model. In various embodiments, the similarity search operation can be configured to search for and cluster vectors in the at least one vector database.

In various embodiments, creating the document retrieval and large language model architecture includes splitting contents of the one or more documents stored in the one or more document storage locations into chunks, creating, using an embedding machine learning model, a plurality of vector embeddings from the chunks, storing the plurality of vector embeddings in the at least one vector database.

At step 310, it is determined whether to modify the report with additional information. In various embodiments, the at least one vector database includes a first vector database and a second vector database, wherein the first vector database includes vectorized data corresponding to documents pertaining to prior data associated with projects other than the current project (such as the prior documents 104 of FIG. 1), and wherein the second vector database includes vectorized data corresponding to documents pertaining to current data associated with the current project (such as the current documents 116 of FIG. 1).

If, at step 310, is determined not to modify the report with additional information, generating and outputting the one or more portions of the report includes, at step 312, creating portions of the report based on the documents pertaining to the prior data. At step 316, the final report generated in this manner is output.

If, at step 310, is determined to modify the report with additional information, generating and outputting the one or more portions of the report includes creating portions of the report based on the documents pertaining to the prior data and creating portions of the report based on the documents pertaining to the current data associated with the current project.

Although FIG. 3 illustrates one example of a method 300 for augmented report generation, various changes may be made to FIG. 3. For example, while shown as a series of steps, various steps in FIG. 3 could overlap, occur in parallel, occur in a different order, or occur any number of times (including zero times).

FIG. 4 illustrates an example electronic device 400 in accordance with various embodiments of this disclosure. The device 400 can be one example of a portion of a client device that interacts with the RAG and LLM system described herein, such as a client device that is used to query the LLM to prompt generation of a report, or other devices such as a device that stores and/or accesses the RAG and LLM system and/or executes the system, a device that stores one or more databased such as one or more of the first and second vector databases 102, 114, or other devices such as server and/or other distributed electronic devices supporting the systems, architectures, processes, and methods of this disclosure. The device 400 can include a controller (e.g., a processor/central processing unit (“CPU”) and/or a graphics processing unit (“GPU”)) 402, a memory unit 404, and an input/output (“I/O”) device 406. The device 400 also includes at least one network interface 408, or network interface controllers (NICs), which can facilitate communications over a communication medium. The device 400 also includes a storage drive 412 used for storing content such as software resources and other data. The components 402, 404, 406, 408, and 412 are interconnected by a data transport system (e.g., a bus) 414. A power supply unit (PSU) 416 provides power to components of the device 400 via a power transport system 418 (shown with data transport system 414, although the power and data transport systems may be separate). Connections can be wired or wireless.

It is understood that the device 400 may be differently configured and that each of the listed components may actually represent several different components. For example, the CPU 402 may actually represent a multi-processor or a distributed processing system; the memory unit 404 may include different levels of cache memory, and main memory; the I/O device 406 may include monitors, keyboards, touchscreens, and the like; the at least one network interface 408 may include one or more network cards providing one or more wired and/or wireless connections to a network 420; and the storage drive 412 may include hard disks and remote storage locations. Therefore, a wide range of flexibility is anticipated in the configuration of the device 400, which may range from a single physical platform configured primarily for a single user or autonomous operation to a distributed multi-user platform such as a cloud computing system.

The device 400 may use any operating system (or multiple operating systems), including various versions of operating systems provided by Microsoft (such as WINDOWS), Apple (such as Mac OS X), UNIX, RTOS, and LINUX, and may include operating systems specifically developed for handheld devices (e.g., IOS, Android, RTOS, Blackberry, and/or Windows Phone), personal computers, servers, and other computing platforms depending on the use of the device 400. The operating system, as well as other instructions (e.g., for telecommunications and/or other functions provided by the device 400), may be stored in the memory unit 404 and executed by the processor 402. The memory unit 404 may include instructions for performing some or all of the steps, process, and methods described herein, such as data for the RAG and LLM system and associated methods of the various embodiments of this disclosure.

The network 420 may be a single network or may represent multiple networks, including networks of different types, whether wireless or wired. For example, the device 400 may be coupled to external devices via a network that includes a cellular link coupled to a data packet network, or may be coupled via a data packet link such as a wide local area network (WLAN) coupled to a data packet network or a Public Switched Telephone Network (PSTN). Accordingly, many different network types and configurations may be used to couple the device 400 with external devices.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
creating a document retrieval and large language model architecture including:
at least one vector database including vectorized data corresponding to one or more documents from one or more document storage locations; and
a large language model;
receiving a query to generate a report associated with a current project using the large language model;
returning, in response to the query, a relevant context generated using the at least one vector database; and
generating and outputting, using the large language model and based on the relevant context, one or more portions of the report.

2. The method of claim 1, wherein generating and outputting the one or more portions of the report includes creating portions of the report based on the one or more documents from the one or more document storage locations according to a report schema.

3. The method of claim 2, wherein the report schema defines various formatting and structural parameters for the report.

4. The method of claim 1, wherein the at least one vector database includes a first vector database and a second vector database, wherein the first vector database includes vectorized data corresponding to documents pertaining to prior data associated with projects other than the current project, and wherein the second vector database includes vectorized data corresponding to documents pertaining to current data associated with the current project.

5. The method of claim 4, further comprising determining whether to modify the report with additional information.

6. The method of claim 5, wherein determining whether to modify the report with additional information includes:
reviewing, using a second large language model, one or more outputs from the large language model; and
determining, based on the review using the second large language model, whether to generate new outputs using the large language model.

7. The method of claim 6, wherein the review using the second large language model provides feedback on an accuracy of the one or more outputs from the large language model.

8. The method of claim 5, wherein, based on determining not to modify the report with additional information, generating and outputting the one or more portions of the report includes creating portions of the report based on the documents pertaining to the prior data.

9. The method of claim 5, wherein, based on determining to modify the report with additional information, generating and outputting the one or more portions of the report includes:
creating portions of the report based on the documents pertaining to the prior data; and
creating portions of the report based on the documents pertaining to the current data associated with the current project.

10. The method of claim 9, wherein creating portions of the report based on the documents pertaining to the prior data and creating portions of the report based on the documents pertaining to the current data associated with the current project includes:
using a third large language model to generate queries based on the current data associated with the current project to retrieve another relevant context associated with the current data;
creating a new input by combining one or more responses from the large language model with information pertaining to the current data and sending the new input to the large language model to generate another response; and
generating one or more outputs based on the new input and the retrieved other context.

11. An electronic device comprising:
at least one processing device; and
memory including instructions that, when executed by the at least one processing device, are configured to cause the electronic device to:
create a document retrieval and large language model architecture including:
at least one vector database including vectorized data corresponding to one or more documents from one or more document storage locations; and
a large language model;
receive a query to generate a report associated with a current project using the large language model;
return, in response to the query, a relevant context generated using the at least one vector database; and
generate and output, using the large language model and based on the relevant context, one or more portions of the report.

12. The electronic device of claim 11, wherein the instructions that, when executed by the at least one processing device, are configured to cause the electronic device to generate and output the one or more portions of the report are further configured to cause the electronic device to create portions of the report based on the one or more documents from the one or more document storage locations according to a report schema.

13. The electronic device of claim 12, wherein the report schema defines various formatting and structural parameters for the report.

14. The electronic device of claim 11, wherein the at least one vector database includes a first vector database and a second vector database, wherein the first vector database includes vectorized data corresponding to documents pertaining to prior data associated with projects other than the current project, and wherein the second vector database includes vectorized data corresponding to documents pertaining to current data associated with the current project.

15. The electronic device of claim 14, wherein the instructions, when executed by the at least one processing device, are further configured to cause the electronic device to determine whether to modify the report with additional information.

16. The electronic device of claim 15, wherein the instructions that, when executed by the at least one processing device, are configured to cause the electronic device to determine whether to modify the report with additional information are further configured to cause the electronic device to:
review, using a second large language model, one or more outputs from the large language model; and
determine, based on the review using the second large language model, whether to generate new outputs using the large language model.

17. The electronic device of claim 16, wherein the review using the second large language model provides feedback on an accuracy of the one or more outputs from the large language model.

18. The electronic device of claim 15, wherein, based on a determination not to modify the report with additional information, the instructions that, when executed by the at least one processing device, are configured to cause the electronic device to generate and output the one or more portions of the report are further configured to cause the electronic device to create portions of the report based on the documents pertaining to the prior data.

19. The electronic device of claim 15, wherein, based on a determination to modify the report with additional information, the instructions that, when executed by the at least one processing device, are configured to cause the electronic device to generate and output the one or more portions of the report are further configured to cause the electronic device to:
create portions of the report based on the documents pertaining to the prior data; and
create portions of the report based on the documents pertaining to the current data associated with the current project.

20. The electronic device of claim 19, wherein the instructions that, when executed by the at least one processing device, are configured to cause the electronic device to create portions of the report based on the documents pertaining to the prior data and create portions of the report based on the documents pertaining to the current data associated with the current project further are further configured to cause the electronic device to:
use a third large language model to generate queries based on the current data associated with the current project to retrieve another relevant context associated with the current data;
create a new input by combining one or more responses from the large language model with information pertaining to the current data and sending the new input to the large language model to generate another response; and
generate one or more outputs based on the new input and the retrieved other context.
